(19) United States
(12) Patent Application Publication
(10) Pub. No.: US 2013/0214165 A1
(43) Pub. Date: Aug. 22, 2013

(54) METHOD AND DEVICE FOR EXAMINATION OF MAIL ITEMS WITH REGARD TO DANGEROUS CONTENT

(71) Applicant: Hubner GmbH, (US)

(72) Inventors: Daniel Hübsch, Kassel (DE); Thorsten Sprenger, Lohfelden (DE)

(73) Assignee: Hubner GmbH, Kassel (DE)

(21) Appl. No.: 13/767,361

(22) Filed: Feb. 14, 2013

(30) Foreign Application Priority Data
Feb. 17, 2012 (DE) DE 10 2012 003 20

(51) Int. Cl. G01N 21/00; G01N 23/00

(52) U.S. Cl. CPC G01N 21/00; G01N 23/00
USPC 250/340; 250/395; 250/338.1; 250/336.1

(57) ABSTRACT

A method is provided for examining mail items with regard to dangerous contents. In a first step, the mail item is scanned in such a manner that the contours of the contents of the mail item are made visible. After an evaluation of the contents of the mail item, a spectral analysis of the content of the mail item occurs in a second step in pre-determinable areas of the mail item.

### CROSS REFERENCE TO RELATED APPLICATION

This patent application claims priority from German patent application Serial No. DE 10 2012 003 201.3, filed Feb. 17, 2012, the entire content of which is incorporated herein in its entirety.

### FIELD OF THE INVENTION

The invention relates to a method and to a device for examining mail with regard to dangerous content.

### BACKGROUND OF THE INVENTION

It happens again and again that for whatever reason, people in the public eye receive mail addressed to them with dangerous contents, more specifically so-called letter bombs. Such letter bombs are already sorted out at a mail sorting center, for example of a ministry. The people working on sorting out such dangerous mail are however exposed to danger to life and limb.

In this respect it is already known to use spectroscopic examination to try to find out if the content of the mail item is dangerous, i.e. for example contains an explosive or not. In such letter bombs, the explosive is frequently located only in a portion of the mail item. In this regard the entire mail item is typically spectroscopically examined in intervals of two centimeters. The duration of each such examination step amounts to about 1 minute. If such a letter must be spectroscopically examined in its entirety, it can frequently take up to one hour. With a number of incoming letters, a spectroscopic examination of a plurality of such letters is barely possible if only due to lack of time.

The object underlying the invention is therefore to shorten the duration of the examination of mail items with regard to a dangerous content.

### SUMMARY OF THE INVENTION

In order to solve the object of the invention it is proposed in a first step of a method for examining mail items with regard to dangerous content, to scan the content of the mail item in such a manner that the contours of the content of the mail item are made visible. After an evaluation of the content of the mail item, a spectral analysis of the content of the mail item occurs in pre-determinable areas of the mail item. The term contour refers to the outline of an object, for example a metallic object. However, if the outer material of the object is one that can be penetrated by the radiation, one will also obtain information on the content of the objects within by way of these contours.

From this, it becomes clear that the mail item is no longer submitted to a spectral analysis in its entirety, but only those areas of the mail item where it can be assumed, for example based on a previous scan by means of X-radiation or by scanning by means of millimeter or sub-millimeter waves (terahertz wave band), that potentially dangerous content, for example explosives, can be found. It has been shown that through such an evaluation, for example of a radiograph of a mail item, it is possible to predict with considerable certainty the areas in which correspondingly problematic substances may be located. In this respect, it was possible to drastically reduce the duration of the examination of a mail item. The spectral instruments that are used operate in the terahertz wave band, more specifically in the range between 0.1 and 5 Terahertz. The pre-determinable areas of a mail item may be chosen by a knowledgeable human operator, such as a supervisor of the operation. The pre-determinable areas could also be chosen by a computer program, such as a program that has “learned” or been taught what areas should undergo a special analysis. Other approaches may also be used.

Another object of the invention is a device for detecting dangerous substances in a mail item, the device having in accordance with the invention a spectral instrument and a reception arrangement with a table for the mail item. The table is disposed in the device so as to be displaceable in the X and Y direction through the reception arrangement and/or the spectral instrument. Hereby, it is assumed that a mail item has already been submitted to a radiographic examination for example and that based on the radiograph, the areas, in which it can be assumed that dangerous substances are present, are visible. After placing the mail item onto the table of the reception arrangement, the area or the areas can be reached, in which dangerous substances are assumed to be located as has already been explained, the table being displaceable through the reception arrangement under the spectral instrument in the X and Y-direction of the Cartesian coordinate system.

A particularly advantageous embodiment of the device is characterized in that the device has a scanning apparatus for the mail item. This means that the device has a combination of a scanning apparatus and a spectral instrument, more specifically in form of a spectral instrument that operates in the Terahertz wave band between 0.1 and 5 Terahertz. Herewith, the scanning for example by means of X-radiation or millimeter or sub-millimeter wave radiation as well as the subsequent spectral analysis can be implemented in one device, which leads to further significant time savings.

According to another particular feature of the invention, it is provided that the device has an apparatus for representing the scanned mail item, i.e. for example a screen on which the scanned mail item can be represented. If the mail item has already been scanned before the examination by way of the spectral instrument, it is necessary to photographically capture the mail item during scanning of the mail item in the scanning apparatus, in order to use this visual representation as a reference during the spectroscopic examination for positioning the mail item on the reception arrangement. If necessary, markings can possibly be disposed on the mail item, in order to ensure that the orientation of the mail item under the spectral instrument on the reception arrangement is identical to the orientation during scanning of the mail item.

It is further provided that the reception arrangement for the postal item is displaceable inside the device into the detection range of the spectral instrument and of the scanning apparatus. From this it becomes clear that the mail item can be scanned and submitted to a spectral analysis in virtually one passage through the device. If the reception arrangement with the table for the mail item extends under the spectral instrument as well as under the scanning apparatus, recording a photograph of the mail item becomes unnecessary, since the orientation of the mail item does not change during the transition from the scanning apparatus on the one hand to the spectral instrument on the other hand.

According to a further feature of the invention, it is provided that the table is displaceable in the Z-direction, which makes it possible to examine not only letters but also for example parcels and small packets. In the simplest case, this occurs because the reception arrangement with the table is adjustable vertically, i.e. in the Z-direction.

In the following, the invention will be exemplarily described in more detail based on the drawings:

### BRIEF DESCRIPTION OF THE FIGURES

FIG. 1 schematically shows the device in a lateral view; and

FIG. 2 shows a view according to line II-II in FIG. 1.

### DETAILED DESCRIPTION OF THE INVENTION

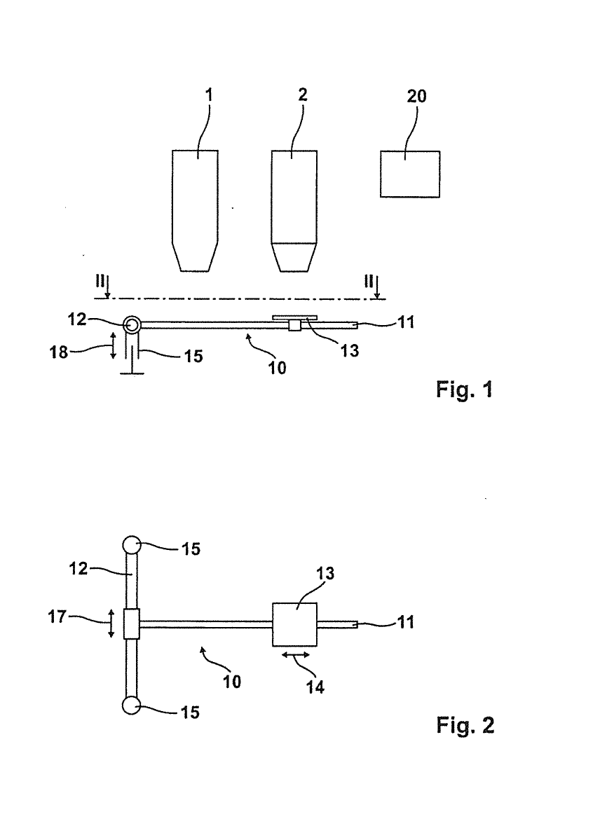

In the representation according to FIG. 1, a radiographic apparatus or millimeter wave scanner 1 is visible as well as a spectral instrument 2 disposed next to it. Below the scanning apparatus there is a reception arrangement 10 with a table 13 for the mail item. The reception arrangement comprises two rails of which one rail 11 is oriented in the X-direction and the other rail 12 is oriented in the Y-direction. The rail 11 oriented in the X-direction is hereby displaceable on the rail 12 in the Y-direction (arrow 17). The rail 11 moreover features the table 13 that is also displaceable on the rail 11 along the arrow 14. Electromotive drives can be provided to ensure the displaceability of the rail 11 on the rail 12 as well as the displaceability of the table 13 on the rail 11. Piston cylinder drives 15 are provided on the reception arrangement 10 in order to ensure the displaceability of the table 13 in the Z-direction (arrow 18). Moreover, a screen 20 is visible in FIG. 1, on which the radiograph of the mail item for instance is representable, in order to be able to identify the places where the spectral analysis must be implemented.

As will be clear to those of skill in the art, the herein described and illustrated embodiments of the present invention may be altered in various ways without departing from the scope or teaching of the present invention. It is the following claims, including all equivalents, which define the scope of the invention.

### REFERENCE NUMBER

1 radiographic apparatus/millimeter wave scanner

2 spectral instrument

10 reception arrangement

11 rail (in X-direction)

12 rail (in Y-direction)

13 table

14 arrow

15 piston cylinder drive

17, 18 arrow

20 screen

1-8. (canceled)

9. A method for examining mail items for dangerous contents, the method comprising:
first, scanning a mail item in such a manner that the contours of the content of the mail item are made visible, whereby the content of the mail item is evaluated; and
second, performing a spectral analysis of the content of the mail item in pre-determinable areas of the mail item.

10. A method in accordance with claim 9, wherein:
the scanning step comprises scanning with radiation in the X-ray or Terahertz wave band.

11. A device for detection of dangerous substances in a mail item, comprising:
a spectral instrument;
a reception arrangement with a table for supporting the mail item;
wherein the table and/or the spectral instrument are disposed in the device so as to be displaceable in the X and Y-direction.

12. A device in accordance with claim 11, wherein the device comprises a scanning apparatus for a mail item.

13. A device in accordance with claim 12, wherein:
the scanning apparatus is a radiographic apparatus or a millimeter wave scanner.

14. A device in accordance with claim 11, further comprising:
an apparatus for representing the scanned mail item.

15. A device in accordance with claim 11, wherein:
the reception arrangement supports the table for the mail item such that the table is displaceable into the detection range of the spectral instrument and into the detection range of the scanning apparatus.

16. A device in accordance with claim 11, wherein:
the table is further displaceable in the Z-direction.

17. A method for examining mail items for dangerous contents, the method comprising:
scanning a mail item in such a manner that the contours of the content of the mail item are made visible;
evaluating the content of the mail item from the scan and defining areas for spectral analysis where problematic substances may be found; and
performing a spectral analysis of the content of the mail item only in the defined areas of the mail item.
